(19) United States
(12) Patent Application Publication
(10) Pub. No.: US 2006/0011702 A1
(43) Pub. Date: Jan. 19, 2006

(54) Solder and packaging therefrom

(76) Inventors: Takuo Funaya, Tokyo (JP); Osamu Myohga, Tokyo (JP); Yoshitsugu Okada, Tokyo (JP); Hiroshi Kubota, Tokyo (JP); Junya Sakurai, Tokyo (JP)

Correspondence Address: SUGHRUE MION, PLLC, 2100 PENNSYLVANIA AVENUE, N.W., SUITE 800, WASHINGTON, DC, 20037, US

(21) Appl. No.: 10/516,708

(22) PCT Filed: Jul. 1, 2003
(86) PCT No.: PCT/JP03/08361

§ 371 Date: Dec. 3, 2004

(30) Foreign Application Priority Data
Jul. 4, 2002 (JP) 2002-195433

(51) Int. Cl. B23K 35/14

(52) U.S. Cl. 228/56.3

(57) ABSTRACT

The solder contains Sn—Zn alloy(s) having a single composition ratio or a plurality of composition ratios, and Sn—Bi—Ag alloy(s) having a single composition ratio or a plurality of composition ratios. The solder includes zinc at 7 to 10 weight % both inclusive, bismuth at 0.001 to 6 weight % both inclusive, silver at 0.001 to 0.1 weight % both inclusive, and the remainder of tin when the alloys are melted in mixture.

### BACKGROUND OF THE INVENTION

1. Field of the Invention

The invention relates to solder used for mounting an electronic component on a circuit substrate and a circuit substrate unit on which an electronic component is mounted through the solder, and more particularly to lead-free solder, as substitution for conventional Sn-37 wt.% Pb eutectic solder, which is capable of soldering at a temperature in the range of 220 to 240 degrees centigrade, and which has a mechanical strength equal to or greater than that of conventional Sn-37 wt.% Pb eutectic solder, and further to a circuit substrate unit using the lead-free solder.

2. Description of the Related Art

In mounting an electronic component onto a circuit substrate, there has been conventionally used creamy solder comprised of mixture of Sn-37 wt. % Pb eutectic solder as metal powder, and flux.

The Sn-37 wt. % Pb eutectic solder has an eutectic temperature of 183 degrees centigrade. A reflow-furnace used for mounting an electronic component onto a substrate is usually designed to provide a maximum temperature in the range of 220 to 240 degrees centigrade therein such that a minimum temperature of the substrate is higher than an eutectic temperature (183 degrees centigrade) of the Sn-37 wt. % Pb eutectic solder, even if the substrate is large in size or a component having high thermal capacity is to be mounted on the substrate.

A temperature in the range of 220 to 240 degrees centigrade is lower than a heat-resistance temperature of an electronic component such as a central processing unit (CPU). Accordingly, it was possible to mount an electronic component on a substrate in the above-mentioned reflow-furnace through the use of Sn-37 wt. % Pb eutectic solder.

Recently, it has been said that lead might be leaked by acid rain out of industrial wastes of products using Sn-37 wt. % Pb eutectic solder therein, and the thus leaked-out lead might be absorbed into a human body through ground water. Thus, lead-free solder is now being developed.

As an example of such lead-free solder, Japanese Patent No. 3027441 has suggested solder alloy predominantly containing Sn—Ag eutectic.

In accordance with the Japanese Patent, the solder alloy predominantly containing Sn-Ag eutectic has a melting point of 220 degrees centigrade or higher, which is higher by about 40 degrees than a melting point of 183 degrees centigrade of conventional Sn-37 wt. % Pb eutectic solder. In addition, the suggested solder alloy has high resistance to thermal fatigue, and hence, can be suitably used in hard environment such as a satellite.

Japanese Patent No. 1664488 (Japanese Patent Application Publication No. 59-189096) has suggested Sn—Zn—Bi lead-free solder to be used as solder alloy providing high soldering strength.

Japanese Patent Application Publication No. 9-277082 has suggested creamy solder comprised of mixture of Sn—Zn powder and Sn—Zn—Bi powder having better wettability than that of Sn—Zn powder and a melting point lower than that of Sn—Zn powder, in order to improve wettability of Sn—Zn solder which is likely to be oxidized and has poor wettability.

Japanese Patent Application Publication No. 8-300182 has suggested solder containing bismuth and tin in an effective amount, and further containing at least one of gold, silver and platinum at X weight % (X<0.99).

Japanese Patent Application Publication No. 10-328880 has suggested Sn—Zn lead-free solder containing silver at 2 to 4 weight %, zinc at 0.5 to 2 weight %, bismuth at 2 to 6 weight %, and the remainder of tin.

Japanese Patent Application Publication No. 11-138292 has suggested lead-free solder paste containing alloy mixture powder at 80 to 95 weight %, and the remainder of flux. The alloy mixture powder contains at least two alloy powders among In powder and binary alloy powder selected from Ag—In, Ag—Sn, Bi—In, Bi—Sn, Cu—Sn, In—Sn, In—Zn, Li—Sn, Mg—Sn and Sn—Zn such that the alloy mixture powder contains at least three metal species.

Japanese Patent Application Publication No. 2000-107882 has suggested lead-free solder powder predominantly containing Sn—Zn or Sn—Zn—Bi. On a surface of lead-free solder alloy powder is formed organic metal compound comprised of malonic acid and metals contained in the solder alloy powder.

The first problem of the conventional solder is that, as mentioned above, Sn-37 wt. % Pb eutectic solder contains lead harmful to a human body.

The second problem is that when an electronic component is mounted on a circuit substrate, a maximum temperature in a furnace exceeds a heat-resistance temperature of the electronic component.

Since the solder alloy predominantly containing Sn—Ag eutectic, suggested in the Japanese Patent No. 3027441, has a melting point of 220 degrees centigrade or higher, when an electronic component is mounted onto a circuit substrate, a furnace has to be heated up to 220 degrees centigrade or higher. If a conventional reflow-furnace suitable for Sn-37 wt. % Pb eutectic solder is used, the reflow-furnace has to be heated to have a maximum temperature of 250 degrees centigrade or higher, when a substrate has a large surface area or an electronic component has high thermal capacity. Since the maximum temperature (250 degrees centigrade) is higher than a heat-resistance temperature of a lot of electronic components such as CPU, even if an electronic component is mounted on a substrate, the thus mounted electronic component has almost no reliability.

In order to solve the problem, it would be necessary to prepare a reflow-furnace which has a smaller difference between a maximum temperature in a furnace and a minimum temperature in a furnace than the same in a conventional reflow-furnace, and which can uniformly heat a substrate. As an alternative, it would be necessary to design an electronic component to have enhanced heat-resistance, however, in which case, semiconductor characteristics may be deteriorated in a Si semiconductor device, for instance.

The third problem is that, as mentioned later, intermetallic compound is formed at an interface between a copper-plate electrode of a circuit substrate and Sn—Zn—Bi lead-free solder, resulting in reduction in tenacity of a portion at which the electrode and the solder are coupled to each other. Hence, a soldering strength of an electronic component is reduced by thermal cycles occurring after the electronic component has been mounted on a substrate. In order to avoid such reduction in a soldering strength, a copper electrode may be plated with gold (Au). However, this results in an increase in the number of steps in fabrication of a circuit substrate unit and fabrication costs of a circuit substrate.

The fourth problem is that a solidus temperature of Sn—Zn—Bi powder is not dependent on a content of Bi in the creamy solder comprised of mixture of Sn—Zn powder and Sn—Zn—Bi powder, as indicated in Table 1 in Japanese Patent Application Publication No. 9-277082.

Consequently, if a profile of a reflow temperature is designed constant, a period of time (a difference in melting points) in which Sn—Zn—Bi alloy surrounds a surface of Sn—Zn powder and removes oxygen out of an oxide film formed on a surface of Sn—Zn powder is not dependent on a content of Bi, after Sn—Zn—Bi powder starts being molten until Sn—Zn powder starts being molten in a reflow-furnace.

### SUMMARY OF THE INVENTION

In view of the above-mentioned problems, it is an object of the present invention to provide a solder having the same workability, use conditions, and bonding-reliability as those of a conventional Sn-37 wt. % Pb eutectic solder, and containing no lead harmful to a human body. It is also an object of the present invention to provide a circuit substrate unit using the solder.

In one aspect of the present invention, there is provided a solder including zinc at 7 to 10 weight % both inclusive, bismuth at 0.001 to 6 weight % both inclusive, silver at 0.001 to 0.1 weight % both inclusive, and the remainder of tin.

For instance, the solder may be in the form of powder.

It is preferable that the powder has a diameter in the range of 20 to 40 micrometers both inclusive.

It is preferable that a difference between a maximum diameter of the powder and a minimum diameter of the powder is equal to or smaller than 10 micrometer.

It is preferable that the solder is mixed in flux.

It is preferable that the flux has a concentration in the range of 9 to 13 weight % both inclusive.

There is further provided a solder including Sn—Zn alloy(s) having a single composition ratio or a plurality of composition ratios, and Sn—Bi—Ag alloy(s) having a single composition ratio or a plurality of composition ratios, the solder including zinc at 7 to 10 weight % both inclusive, bismuth at 0.001 to 6 weight % both inclusive, silver at 0.001 to 0.1 weight % both inclusive, and the remainder of tin when the alloys are melted in mixture.

In another aspect of the present invention, there is provided a circuit substrate unit including a circuit board, and at least one electronic component soldered onto the circuit board, wherein the electronic component is soldered onto the circuit board through a solder, and the solder contains zinc at 7 to 10 weight % both inclusive, bismuth at 0.001 to 6 weight % both inclusive, silver at 0.001 to 0.1 weight % both inclusive, and the remainder of tin.

For instance, the solder may be in the form of powder.

It is preferable that the powder has a diameter in the range of 20 to 40 micrometers both inclusive.

It is preferable that a difference between a maximum diameter of the powder and a minimum diameter of the powder is equal to or smaller than 10 micrometer.

It is preferable that the solder is mixed in flux.

It is preferable that the flux has a concentration in the range of 9 to 13 weight % both inclusive.

There is further provided a circuit substrate unit including a circuit board, and at least one electronic component soldered onto the circuit board, wherein the electronic component is soldered onto the circuit board through a solder, and the solder contains Sn—Zn alloy(s) having a single composition ratio or a plurality of composition ratios, and Sn—Bi—Ag alloy(s) having a single composition ratio or a plurality of composition ratios, the solder including zinc at 7 to 10 weight % both inclusive, bismuth at 0.001 to 6 weight % both inclusive, silver at 0.001 to 0.1 weight % both inclusive, and the remainder of tin when the alloys are melted in mixture.

The advantages obtained by the aforementioned present invention will be described hereinbelow.

As having been explained above, since the solder in accordance with the present invention does contain a material such as lead, which dissolved into ground due to acid rain, and enters a human body through ground water, the solder is not harmful to a human body.

A liquidus temperature rises beyond a melting point of conventional Sn-37 wt. % Pb eutectic solder, if Zn is added to Sn at 7 to 10 weight %. The solder in accordance with the present invention lowers the thus raised liquidus temperature by adding bismuth at 6 weight % or smaller, ensuring that a liquidus temperature rises by 10 to 20 degrees relative to a melting point of Sn-37 wt. % Pb eutectic solder. Accordingly, it is possible to carry out soldering at a temperature range in which an electronic component has a resistance to heat and which is the same as a temperature range for conventional Sn-37 wt. % Pb eutectic solder. In addition, it is not necessary to newly prepare a reflow-furnace capable of uniformly entirely heating a substrate, and it is possible to use a reflow-furnace having been used for conventional Sn-37 wt. % Pb eutectic solder, without any change.

Since the solder in accordance with the present invention contains Ag at 0.1 weight % or smaller in Sn—Zn—Bi solder, the solder can have an increased breaking elongation and an increased tensile strength, and prevent enlargement of particles of intermetallic compound comprised of Cu and Zn. Hence, high reliability in solder-bonding is ensured in initial steps in a fabrication process or after a thermal cycle test.

The solder in accordance with the present invention makes it no longer necessary to plate a copper electrode with Au, ensuring that a circuit substrate unit can be fabricated at the same cost for fabricating a circuit substrate unit including conventional Sn-37 wt. % Pb eutectic solder.

The solder in accordance with the present invention may be formed as a creamy solder comprised of a mixture of Sn—Zn alloy powders, and Sn—Bi—Ag powders having a smaller melting point that the same of Sn—Zn alloy powders and further having good wettability to an electrode. Hence, there can be obtained good wettability to an electrode or a terminal of an electronic component, ensuring it possible to have a large area at which an electronic component is soldered to a substrate, and have an increased mechanical strength.

Since an electronic component is mounted onto an electrode of a circuit substrate through the solder having the above-mentioned characters in the circuit substrate unit in accordance with the present invention, it would be possible to solder an electronic component to a substrate with high reliability.

The above and other objects and advantageous features of the present invention will be made apparent from the following description made with reference to the accompanying drawings, in which like reference characters designate the same or similar parts throughout the drawings.

### BRIEF DESCRIPTION OF THE DRAWINGS

FIG. 1 illustrates a relation between a Bi content and a melting point in the solder in accordance with the present invention.

FIG. 2 illustrates a relation between an Ag content and a melting point in the solder in accordance with the present invention.

FIG. 3 is a cross-sectional view of a circuit substrate unit in accordance with the first example of the present invention.

FIG. 4A is a planar view and FIG. 4B is a side view both used for explanation of a method of measuring a shearing strength of the solder in accordance with the first example of the present invention.

FIG. 5 illustrates a relation between a Bi content and a shearing strength in the solder in accordance with the first example of the present invention.

FIG. 6 illustrates a relation between a Bi content and a tensile strength in the solder in accordance with the second example of the present invention.

FIG. 7 illustrates a relation between a thermal cycle and a shearing strength in the solder in accordance with the third example of the present invention.

FIG. 8 illustrates a relation between an Ag content and a tensile strength in the solder in accordance with the fourth example of the present invention.

FIG. 9 illustrates a relation between an Ag content and breaking elongation in the solder in accordance with the fifth example of the present invention.

FIG. 10 illustrates a relation between an Ag content and a Vickers hardness in the solder in accordance with the fifth example of the present invention.

FIGS. 11A and 11B illustrate a relation between a thermal cycle and a shearing strength in the solder in accordance with the sixth example of the present invention.

FIG. 12A is a SEM photograph of a broken-out section.

FIG. 12B illustrate EDX images for showing Zn profile in the solder in accordance with the sixth example of the present invention.

FIG. 12C illustrate EDX images for showing Cu profile in the solder in accordance with the sixth example of the present invention.

FIG. 13A is a SEM photograph of a broken-out section.

FIG. 13B illustrate EDX images for showing Zn profile in the solder in accordance with the sixth example of the present invention.

FIG. 13C illustrate EDX images for showing Cu profile in the solder in accordance with the sixth example of the present invention.

FIG. 14A is a cross-sectional view of a soldered portion before the solder is broken out in the circuit substrate unit in accordance with the sixth example of the present invention.

FIG. 14B is a cross-sectional view of a soldered portion before the solder is broken out in the circuit substrate unit in accordance with the reference sample 1.

FIG. 15A is a cross-sectional SEM photograph taken just after the solder in accordance with the seventh example of the present invention was printed onto a copper electrode.

FIG. 15B is a cross-sectional SEM photograph taken after heated at a preheat temperature.

FIG. 15C is a cross-sectional SEM photograph taken after soldered.

FIG. 16 is a cross-sectional view of a structure observed just after the solder in accordance with the eighth example of the present invention was printed onto a copper plate.

### DESCRIPTION OF THE PREFERRED EMBODIMENTS

The solder in accordance with the present invention contains alloys comprised of four elements, that is, tin (Sn), zinc (Zn), bismuth (Bi) and silver (Ag).

Sn—Zn alloy would have an eutectic composition when it contains zinc at 8.8 weight %, and has an eutectic temperature of 199 degrees centigrade. The eutectic temperature of 199 degrees centigrade is closest to an eutectic temperature of 183 degrees centigrade of Sn-37 wt. % Pb eutectic solder among eutectic temperatures of binary alloys.

In general, a binary eutectic alloy has a composition denser than that of alloys having non-eutectic composition. Hence, a binary alloy has a sufficient mechanical strength, small contraction caused by coagulation, sufficient fluidity when molten, small element segregation, and a high resistance to corrosion.

Taking such characteristics of a binary eutectic alloy into consideration, the solder in accordance with the present invention is designed to contain zinc at 7 to 10 weight % both inclusive around 8.8 weight % at which Sn—Zn alloy turns into an eutectic composition. As a result, the solder in accordance with the present invention predominantly containing alloys having a composition close to that of Sn—Zn eutectic alloy can have superior mechanical strength and physical and chemical characteristics, and can be used in temperature conditions closest to temperature conditions in which Sn-37 wt. % Pb eutectic solder is to be used for mounting an electronic component onto a substrate, in comparison with solders predominantly containing other eutectic alloys or other alloys having a composition close to that of an eutectic alloy.

Hereinbelow are explained preferred embodiments in accordance with the present invention, with reference to the drawings.

In the explanation made hereinbelow, the solder is designed to contain zinc at 8 weight %. However, it was found out by the inventors that the solder containing zinc at a certain weight % other than 8 weight % provides the same advantages as those provided by the solder containing zinc at 8 weight %, if the solder contains zinc at a weight % ranging from 7 to 10 weight % both inclusive.

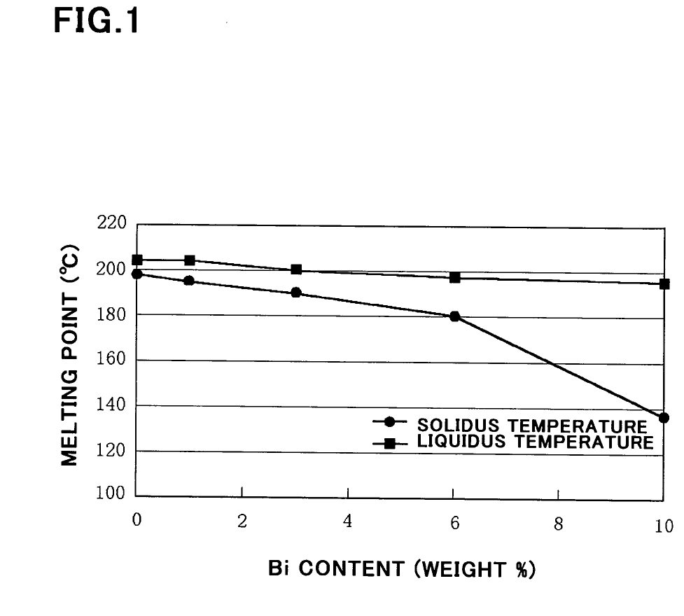

FIG. 1 illustrates a relation between a Bi content (weight %) and a melting point (° C.) in the solder in accordance with the present invention.

The solder alloy was fabricated by putting elements each having an accurately measured weight, into a crucible, heating the elements in inert gas atmosphere, sufficiently stirring the elements, and rapidly cooling the elements. The solder alloy used for measuring the relation between a Bi content and a melting point, illustrated in FIG. 1, has a composition comprised of Zn at 8 weight %, Ag at 0.08 weight %, Bi at 0 to 10 weight %, and the remainder of Sn.

FIG. 1 shows the dependency of a liquidus temperature and a solidus temperature on a Bi content in the solder alloy bulk having the above-mentioned composition, in which the liquidus and solidus temperatures are calculated from a peak observed in DSC (differential scanning calorimeter) measurement at a temperature-increase rate of 10° C./min.

In binary system, tin and bismuth turn into an eutectic composition at Sn-57 wt. % Bi, and an eutectic temperature thereof is 139 degrees centigrade. In the first embodiment, as a Bi content increases, the liquidus temperature and the solidus temperature lower. If a Bi content reaches 10 weight %, the solidus temperature lowers down to 140 degrees centigrade or lower.

A test for evaluating reliability of a product including an electronic component or other components includes a test in which a product is kept at a high temperature such as 125 or 150 degrees centigrade. Hence, if a Bi content reaches 10 weight %, liquid phase appears in a solder when the solder is kept at a high temperature, resulting in loss of reliability.

If the solder contains Bi at 6 weight %, the solidus temperature is 180 degrees centigrade, which is almost equal to a melting point of 183 degrees centigrade of conventional Sn-37 wt. % Pb.

When the solder contains Bi at 0 to 6 weight %, the liquidus temperature is about 200 degrees centigrade, in which case, a difference between the liquidus temperature and a melting point of 183 degrees centigrade of conventional Sn-37 wt. % Pb is about 10 to 20 degrees. Accordingly, it would be possible to mount an electronic component on a substrate through the use of a conventional reflow-furnace in which an electronic component is mounted on a substrate through conventional Sn-37 wt. % Pb eutectic solder.

In view of the above-mentioned, it is preferable that the solder contains Bi at 6 weight % or smaller in order to ensure high bonding-reliability after an electronic component or other components is(are) mounted on a substrate through the solder. A technically controllable minimum content of Bi is 0.001 weight %.

The above-mentioned result is applied to the solder containing Ag at 0.1 weight % or smaller. If the solder contains Ag at 0.1 weight % or smaller, the liquidus temperature scarcely varies, and the solidus temperature varies only by about 2 degrees.

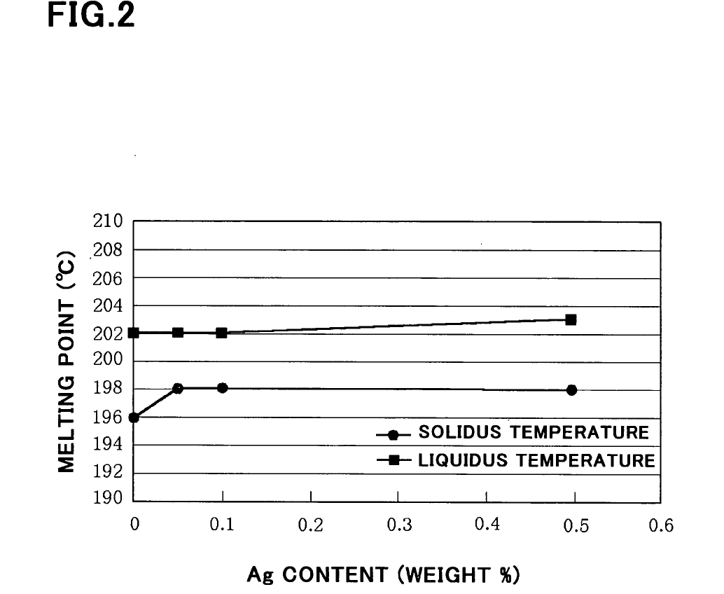

FIG. 2 illustrates a relation between an Ag content (weight %) and a melting point (degrees centigrade) in the solder in accordance with the present invention.

The solder alloy used for measuring the relation between an Ag content and a melting point, illustrated in FIG. 2, has a composition comprised of Zn at 8 weight %, Bi at 1 weight %, Ag at 0 to 0.5 weight %, and the remainder of Sn. The methods of fabricating the solder alloy and measuring a melting point are the same as the methods of doing the same in FIG. 1.

In an overall area of an Ag content, the solidus temperature is higher than a melting point of 183 degrees centigrade of conventional Sn-37 wt. % Pb eutectic solder, and varies only by about two degrees from 196 degrees centigrade to 198 degrees centigrade.

In contrast, the liquidus temperature is not dependent on an Ag content, and is kept almost constant, when an Ag content is equal to or smaller than 0.1 weight %.

However, if an Ag content of the solder exceeds 0.1 weight %, the liquidus temperature rises, contrary to a Bi content shown in FIG. 1. Hence, if an Ag content exceeds 0.1 weight %, the liquid temperature becomes higher than a liquid temperature in an Ag-free solder. Thus, the solder is not suitable for mounting an electronic component onto a substrate therethrough with respect to a temperature at which an electronic component is soldered onto a substrate, because it would not be possible to use a conventional reflow-furnace used for Sn-37 wt. % Pb eutectic solder. Accordingly, it is preferable that the solder contains Ag at 0.1 weight % or smaller. A technically controllable minimum content of Ag is 0.001 weight %.

In view of the above-mentioned, it is preferable that the solder in accordance with the present invention contains Zn at 7 to 10 weight %, bi at 6 weight % or smaller, Ag at 0.1 weight % or smaller, and the remainder of Sn. There was fabricated a plurality of circuit substrate units each comprising a circuit substrate, an electronic component mounted on the circuit substrate, and a solder through which the electronic component was mounted on the circuit substrate and which had such a composition as mentioned above. A mechanical strength and alloy structure of the solder in accordance with the present invention were tested for the circuit substrate units.

### EXAMPLE 1

There were fabricated four solder alloys having the following compositions.

(Solder 1)

Zn content: 8 weight %
Ag content: 0.08 weight %
Bi content: 0 weight %
Remainder: Sn
   (Solder 2)
Zn content: 8 weight %
Ag content: 0.08 weight %
Bi content: 1 weight %
Remainder: Sn
   (Solder 3)
Zn content: 8 weight %
Ag content: 0.08 weight %
Bi content: 3 weight %
Remainder: Sn
   (Solder 4)
Zn content: 8 weight %
Ag content: 0.08 weight %
Bi content: 6 weight %
Remainder: Sn

Then, the solders 1 to 4 were powdered, and powders having a diameter in the range of 20 to 40 micrometers were separated out. Then, the powders were mixed with weakly-active flux such that a content of the flux was 12 weight %, to thereby fabricate four creamy solders.

Then, those creamy solders were printed onto Cu substrate electrodes formed on circuit substrates, through a metal mask. Then, a chip resistor having a size of 1.6 mm×0.8 mm was mounted on each of the creamy solders.

Then, the circuit substrates were heated in a conventional reflow-furnace used for Sn-37 wt. % Pb eutectic solder to thereby melt the creamy solders. Thus, Cu substrate electrodes formed on the circuit substrates and electrodes of the chip resistors were soldered to each other.

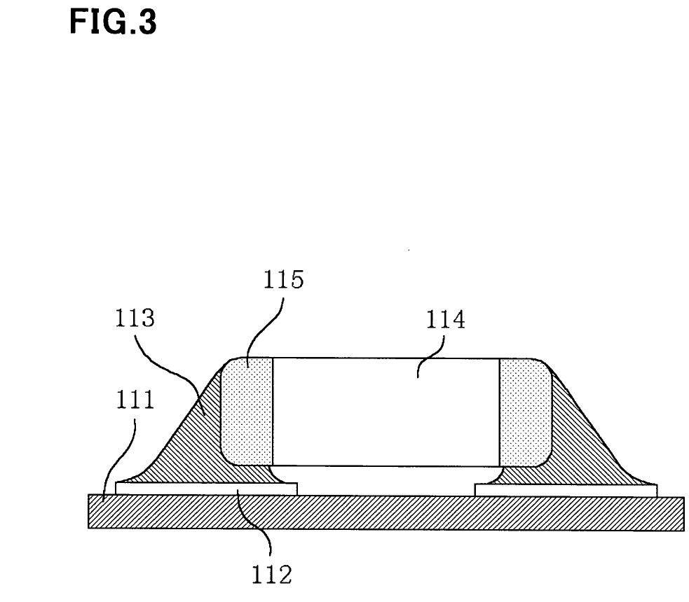

FIG. 3 is a cross-sectional view of the circuit substrate unit including a chip resistor soldered onto a circuit substrate.

As illustrated in FIG. 3, a Cu substrate electrode 112 is mounted on a circuit substrate 111, and a chip resistor electrode 115 of a chip resistor 114 and the Cu substrate electrode 112 are coupled to each other through a solder 113.

The solder 113 had sufficient wettability to the Cu substrate electrode 112 and the chip resistor electrode 115. Thus, the chip resistor electrode 115 and the Cu substrate electrode 112 were mechanically firmly soldered to each other.

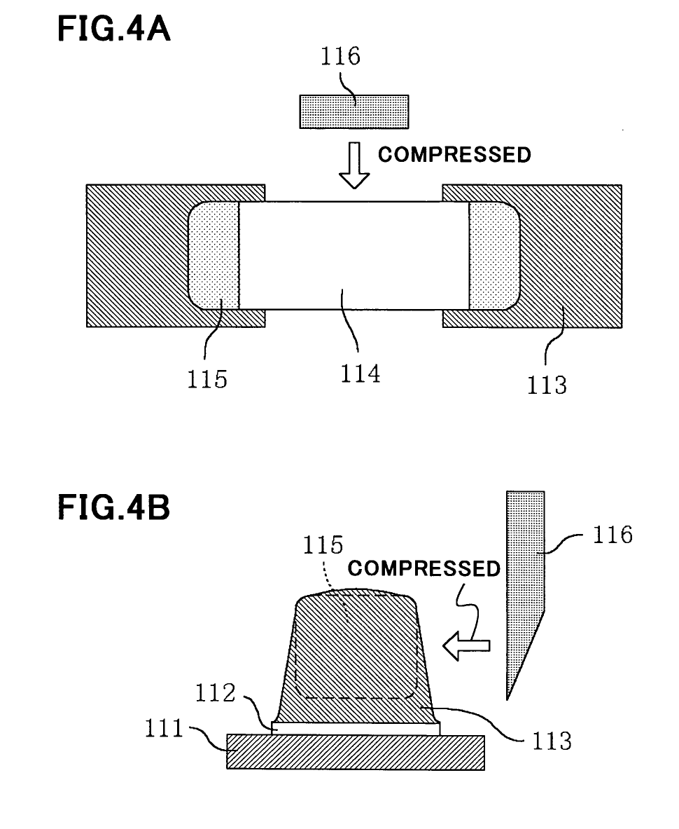

Then, as illustrated in FIGS. 4A and 4B, the chip resistor 114 was compressed at a center of a longer side with a jig 116 for measuring a shearing strength for measuring a peeling strength (a shearing strength) of the chip resistor 114 in a shearing direction.

In FIGS. 4A and 4B, parts or elements that correspond to those of FIG. 3 have been provided with the same reference numerals, and are not explained.

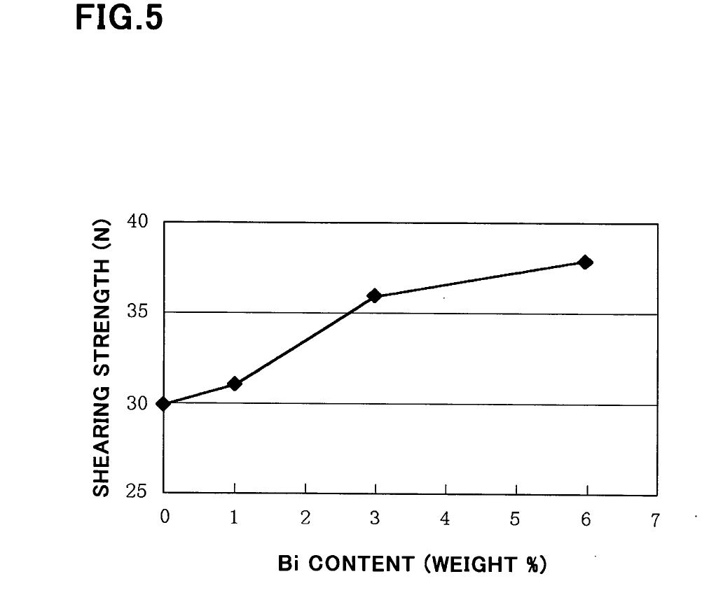

FIG. 5 illustrates the dependency of the measured shearing strength (N) on a Bi content (weight %) in Example 1.

As illustrated in FIG. 5, as a Bi content rises, a shearing strength rises. Accordingly, it was found out that the mechanical strength rises in accordance with a Bi content unless a Bi content is equal to or smaller than 6 weight %, ensuring enhancement in reliability in a mechanical strength of a circuit substrate unit including a circuit substrate on which an electronic component is mounted.

### Example 2

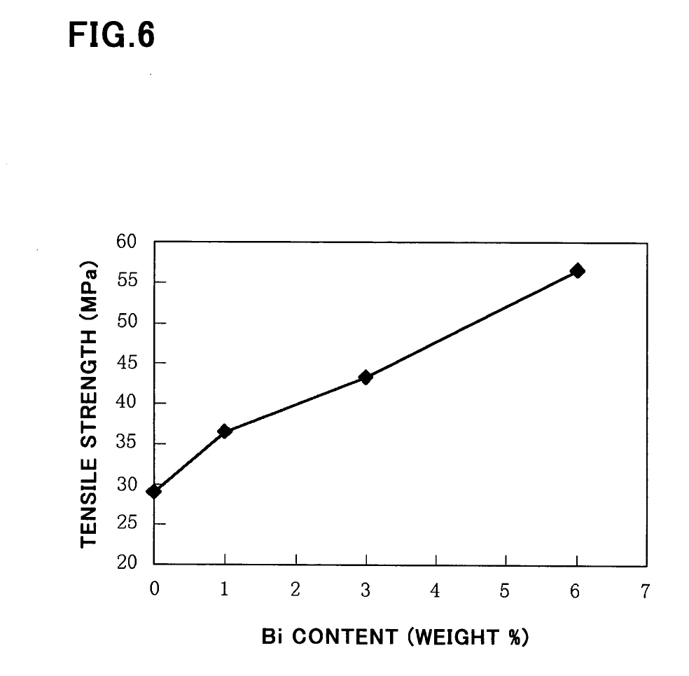

FIG. 6 illustrates a relation between a Bi content (weight %) and a tensile strength (MPa) in the solder in accordance with Example 2.

There were fabricated four solder alloys having the following compositions.

(Solder 1)

Zn content: 8 weight %
Ag content: 0.01 weight %
Bi content: 0 weight %
Remainder: Sn
   (Solder 2)
Zn content: 8 weight %
Ag content: 0.01 weight %
Bi content: 1 weight %
Remainder: Sn
   (Solder 3)
Zn content: 8 weight %
Ag content: 0.01 weight %
Bi content: 3 weight %
Remainder: Sn
   (Solder 4)
Zn content: 8 weight %
Ag content: 0.01 weight %
Bi content: 6 weight %
Remainder: Sn

Then, a test piece for measuring a tensile strength was cut out of those solder alloy bulks, and a tensile strength test was carried out in accordance with a tensile strength test defined in JIS Z2241.

FIG. 6 was obtained based on the results of the tensile strength test.

As illustrated in FIG. 6, as a Bi content rises, a tensile strength rises. Accordingly, similarly to the example 1, it was found out in the second example 2 that the mechanical strength rises in accordance with a Bi content unless a Bi content is equal to or smaller than 6 weight %.

However, it was also found out in the tensile strength test that as a Bi content raised, a breaking elongation reduced. This is caused by an increase in materially fragile Bi. If a breaking elongation is significantly small, reliability of a soldered portion against a thermal cycle is reduced. Hence, it is preferable that the solder does not contain Bi too much.

### Example 3

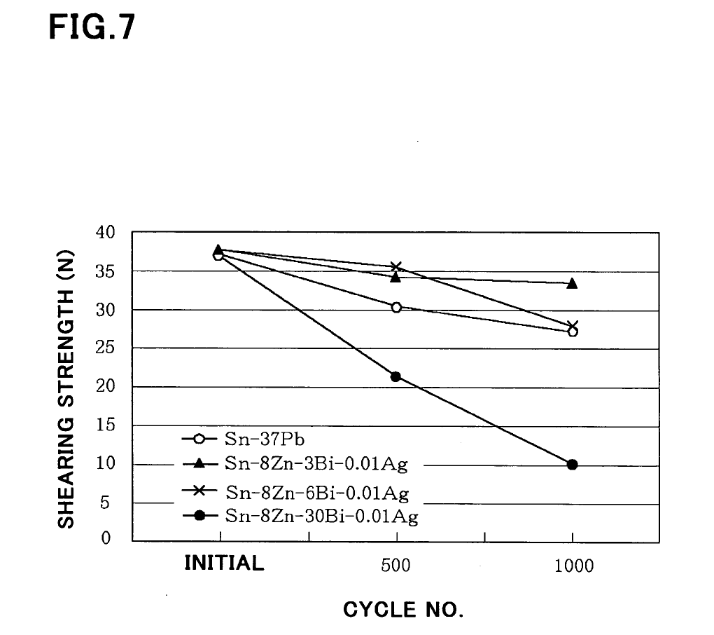

FIG. 7 illustrates a relation between a thermal cycle and a shearing strength (N) in the solder in accordance with Example 3.

For comparison, FIG. 7 further illustrates data concerning Sn-37 wt. % Pb eutectic solder.

There were fabricated three solder alloys having the following compositions.

(Solder 1)

Zn content: 8 weight %
Ag content: 0.01 weight %
Bi content: 3 weight %
Remainder: Sn
   (Solder 2)
Zn content: 8 weight %
Ag content: 0.01 weight %
Bi content: 6 weight %
Remainder: Sn
   (Solder 3)
Zn content: 8 weight %
Ag content: 0.01 weight %
Bi content: 30 weight %
Remainder: Sn

Then, the solders 1 to 3 were powdered, and powders having a diameter in the range of 20 to 40 micrometers were separated out. Then, the powders were mixed with weakly-active flux such that a content of the flux was in the range of 10 to 12 weight %, to thereby fabricate three creamy solders.

Then, chip resistors each having a size of 1.6 mm×0.8 mm were mounted on copper plate electrodes formed on circuit substrates, through the use of those creamy solders, in the same manner as Example 1. A peeling strength of the chip resistors in a shearing direction was measured for each of the circuit substrates, similarly to Example 1, both immediately after the chip resistors were mounted on the circuit substrates, and after a thermal cycle test in which each of the circuit substrates is kept alternately at −40 and 125 degrees centigrade for about 10 to 30 minutes was carried out for each of the circuit substrates by 500 to 1000 cycles.

As illustrated in FIG. 7, if the solder (▴, ×, ●) in accordance with Example 3 contains Bi at 6 weight % or smaller (▴, ×), the solder provides a shearing strength equal to or higher than the same of Sn-37 wt. % Pb eutectic solder (◯) even after 1000 cycles in the thermal cycle test.

However, if the solder contains Bi at 30 weight % or higher (●), a shearing strength thereof is lower than that of Sn-37 wt. % Pb eutectic solder except immediately after an electronic component has been mounted on a circuit substrate. In addition, after 1000 cycles, a shearing strength of the solder containing Bi at 6 weight % or higher is lower than that of the conventional Sn-37 wt. % Pb eutectic solder.

Accordingly, when the solder is requested to have reliability for ensuring a sufficient shearing strength even over 1000 cycles in a thermal cycle test, it is not preferable for the solder to contain Bi therein at 6 weight % or higher, as substitution for the conventional Sn-37 wt. % Pb eutectic solder.

Furthermore, if an electronic component or a circuit substrate on which an electronic component is to be mounted contains lead therein, lead may enter the solder while being heated in a reflow-furnace, in which case, if the solder contains Bi much, a Sn—Pb—Bi alloy having a solidus temperature equal to or smaller than 100 degrees centigrade is formed in the solder. The higher a Bi content in the solder is, the larger an area of the solder having a low melting point is, resulting in reduction in bonding-reliability to variance in temperature environment.

In view of the above-mentioned, it is preferable for the solder to contain Bi at 6 weight % or smaller.

### Example 4

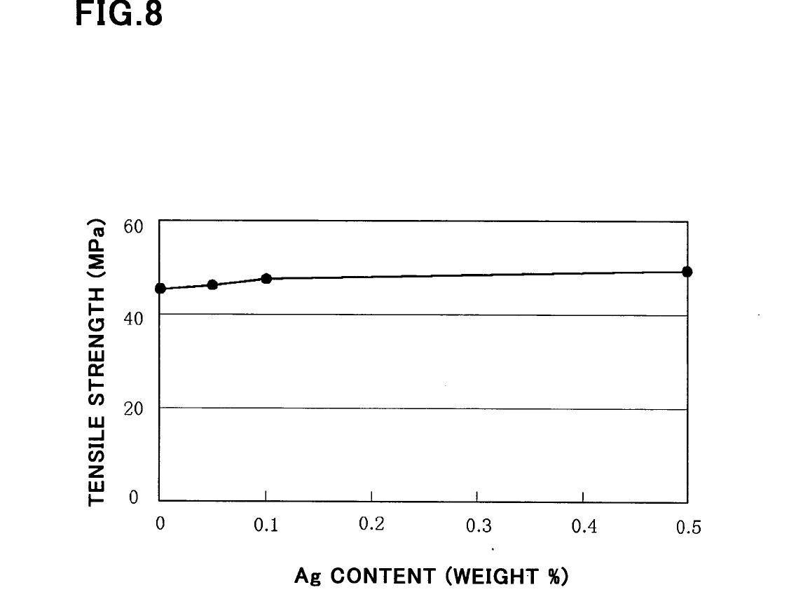

FIG. 8 illustrates a relation between an Ag content (weight %) and a tensile strength (MPa) in the solder in accordance with Example 4.

There were fabricated four solder alloys having the following compositions.

(Solder 1)

Zn content: 8 weight %
Ag content: 0 weight %
Bi content: 1 weight %
Remainder: Sn
   (Solder 2)
Zn content: 8 weight %
Ag content: 0.05 weight %
Bi content: 1 weight %
Remainder: Sn
   (Solder 3)
Zn content: 8 weight %
Ag content: 0.1 weight %
Bi content: 1 weight %
Remainder: Sn
   (Solder 4)
Zn content: 8 weight %
Ag content: 0.5 weight %
Bi content: 1 weight %
Remainder: Sn

Then, similarly to Example 2, a test piece for measuring a tensile strength was cut out of those solder alloy bulks, and a tensile strength test was carried out in accordance with a tensile strength test defined in JIS Z 2241.

FIG. 8 was obtained based on the results of the tensile strength test.

As illustrated in FIG. 8, as an Ag content rises, a tensile strength gently rises. Accordingly, similarly to a Bi content in Example 2, a tensile strength rises in accordance with an Ag content.

However, if the solder contains Ag at 0.1 weight % or higher, a tensile strength scarcely varies.

### Example 5

First, there were fabricated six solder alloys having the following compositions.

(Solder 1)

Zn content: 8 weight %
Ag content: 0 weight %
Bi content: 1 weight %
Remainder: Sn
   (Solder 2)
Zn content: 8 weight %
Ag content: 0.025 weight %
Bi content: 1 weight %
Remainder: Sn
   (Solder 3)
Zn content: 8 weight %
Ag content: 0.05 weight %
Bi content: 1 weight %
Remainder: Sn
   (Solder 4)
Zn content: 8 weight %
Ag content: 0.075 weight %
Bi content: 1 weight %
Remainder: Sn
   (Solder 5)
Zn content: 8 weight %
Ag content: 0.1 weight %
Bi content: 1 weight %
Remainder: Sn
   (Solder 6)
Zn content: 8 weight %
Ag content: 0.5 weight %
Bi content: 1 weight %
Remainder: Sn

Then, similarly to Example 4, a test piece for measuring a tensile strength was cut out of the six solder alloy bulks, and a tensile strength test was carried out in accordance with a tensile strength test defined in JIS Z 2241 to thereby measure a breaking elongation (%).

Furthermore, a Vickers hardness test was carried out to those six solder alloy bulks in accordance with JIS Z 2244 to thereby measure a Vickers hardness. A test load was 15 gf.

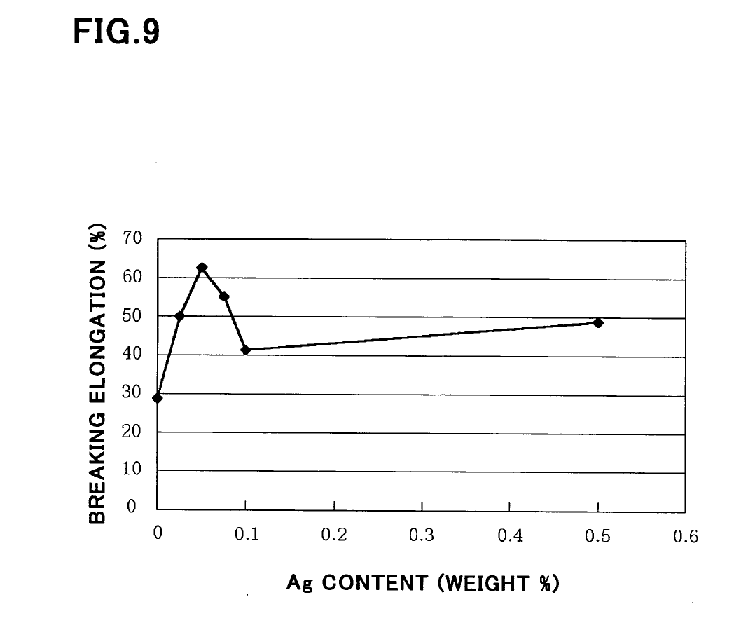

FIG. 9 illustrates the dependency of an Ag content (weight %) on a breaking elongation (%).

As illustrated in FIG. 9, the breaking elongation increases as an Ag content increases from zero, and is in maximum when an Ag content is about 0.05 weight %. Thereafter, the breaking elongation decreases, and starts increasing again when an Ag content is about 0.1 weight %. When an Ag content is equal to or greater than 0.25 weight %, but equal to or smaller than 0.075 weight %, the breaking elongation is about twice greater than a breaking elongation obtained in a solder not containing Ag.

In addition, the breaking elongation in the solder containing Ag at 0.1 weight % is about 30% greater than a breaking elongation measured in conventional Sn-37 wt. % Pb solder in the same manner.

In a bonding-structure having no leads such as a flip-chip or BGA (Ball Grid Array), if there is a high difference in a thermal expansion coefficient between solder alloy and an object to be soldered, such as an electronic component or a circuit substrate electrode, use of solder having a small breaking elongation would often cause breakage starting from a small soldered portion, that is, a gap or a cut-out such as crack or void, due to temperature increase or temperature drop.

The above-mentioned results show that the solder in accordance with Example 5 has a superior breaking elongation by virtue of content of Ag, when used for mounting an electronic component on a circuit substrate therethrough, in comparison with a solder not containing Ag, and that the solder in accordance with Example 5 has a sufficient breaking elongation as substitution for Sn-37 wt. % Pb solder. In particular, when an Ag content of the solder is equal to or higher than 0.025 weight %, but equal to or smaller than 0.075 weight %, the solder has a breaking elongation about twice greater than a breaking elongation of a solder not containing Ag. This is an explicit advantage of the solder in accordance with Example 5 in comparison with a solder not containing Ag.

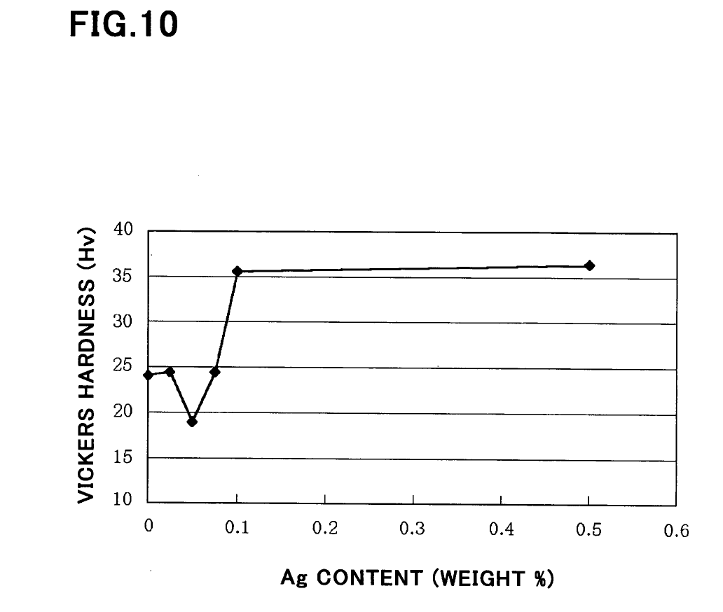

FIG. 10 illustrates the dependency of an Ag content (weight %) on a Vickers hardness (Hv).

As illustrated in FIG. 10, when an Ag content is in the range of 0 to 0.025 weight %, the Vickers hardness slightly increases, but is kept almost constant. When an Ag content is in the range of about 0.025 to 0.075 weight %, the Vickers hardness is lower than a Vickers hardness of a solder not containing Ag. That is, when an Ag content is in the range of about 0.025 to 0.075 weight %, the solder in accordance with Example 5 is softer than a solder not containing Ag, and hence, has superior solder-characteristics.

When an Ag content is 0.05 weight %, the Vickers hardness of the solder is in minimum, specifically, 20 Hv or smaller which is almost equal to a Vickers hardness of conventional Sn-37 wt. % Pb solder.

When an Ag content is equal to or higher than 0.075 weight %, the Vickers hardness increases. When an Ag content is 0.1 weight %, the Vickers hardness is about 1.5 times greater than a Vickers hardness of a solder not containing Ag. When an Ag content exceeds 0.1 weight %, the Vickers hardness is almost constant.

### Example 6

There were fabricated two solder alloys having the following compositions.

(Solder 1)

Zn content: 6 weight %
Ag content: 0.1 weight %
Bi content: 8 weight %
Remainder: Sn
   (Solder 2)
Zn content: 6 weight %
Ag content: 0 weight %
Bi content: 8 weight %
Remainder: Sn

Then, the solders 1 and 2 were powdered, and powders having a diameter in the range of 20 to 40 micrometers were separated out. Then, the powders were mixed with weakly-active flux such that a content of the flux was in the range of 10 to 12 weight %, to thereby fabricate two creamy solders.

Then, chip resistors each having a size of 1.6 mm×0.8 mm were mounted on electrodes formed on circuit substrates, through the use of those creamy solders, in the same manner as Example 3. Then, a thermal cycle test was carried out to the circuit substrates for measuring a peeling strength of the chip resistors in a shearing direction. The number of thermal cycles is 250 cycles at maximum and 500 cycles at maximum. There were used circuit substrates having copper electrodes, and circuit substrates having copper electrodes coated with a Ni layer and an Au layer in this order by plating or evaporation.

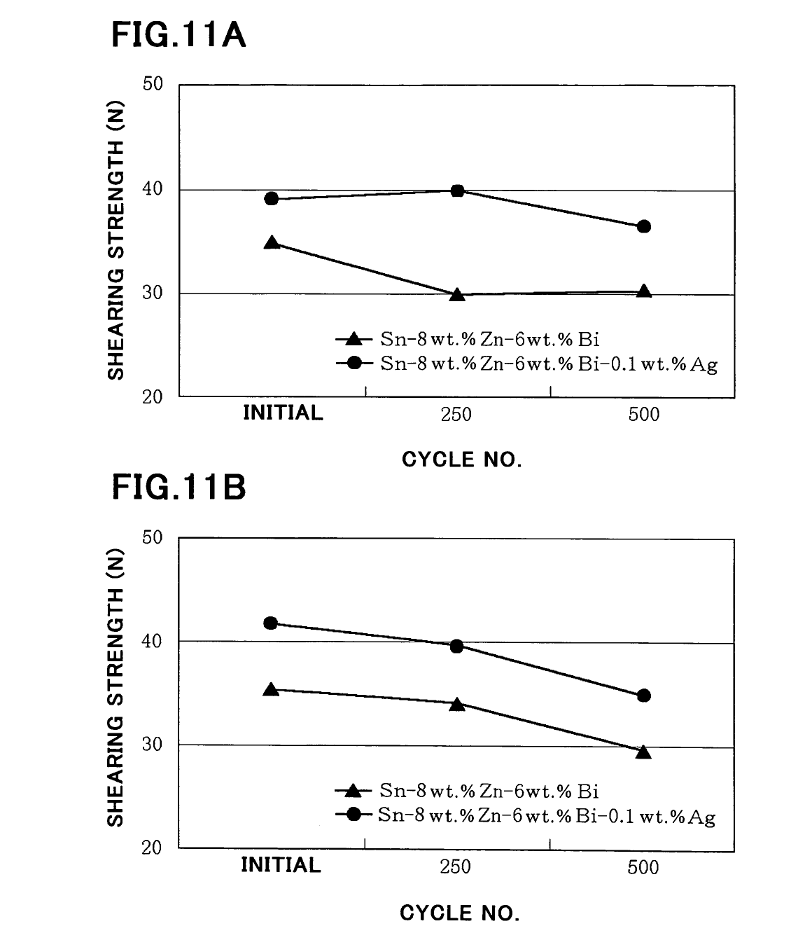

FIG. 11 is a graph showing the dependency of a shearing strength (N) on a thermal cycle.

As illustrated in FIG. 11A, when a circuit substrate including non-coated copper electrodes, the solder (●) containing Ag at 0.1 weight % explicitly has a higher shearing strength than a solder (▴) not containing Ag before or after a thermal cycle was applied to the solder.

As illustrated in FIG. 11B, when a circuit substrate including copper electrodes coated with a Ni layer and an Au layer by plating or evaporation, the solder (●) containing Ag at 0.1 weight % explicitly has a higher shearing strength than a solder (▴) not containing Ag before or after a thermal cycle was applied to the solder.

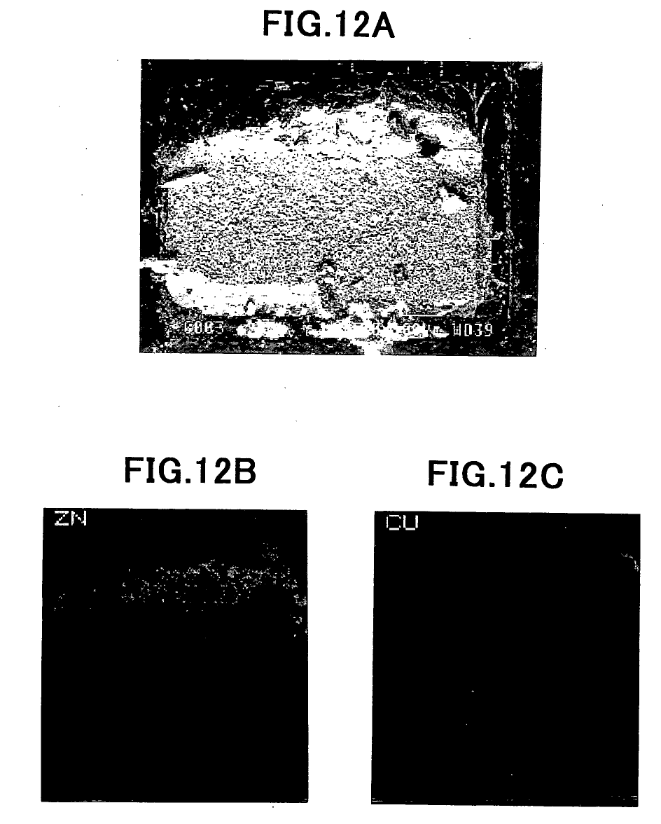

FIG. 12A is a SEM (Scanning Electron Microscope) photograph of a broken-out section of a solder from which a chip resistor was peeled off after the above-mentioned measurement of a peeling strength, FIG. 12B is EDX (Energy Dispersive X-ray spectroscope) images (Zn profile), and FIG. 12C is EDX images (Cu profile).

The solder used contains Ag at 0.1 weight %, and the circuit substrate used includes non-coated copper electrodes. The number of thermal cycles is 500.

Comparing FIGS. 12A, 12B and 12C to one another, it is obvious that Cu and Zn do not exist in a common area in the broken-out section, and Cu is scarcely found in an area where the solder exists. This means that Cu melts out of an electrode into the solder, and resultingly, there is formed a brittle Cu—Zn intermetallic compound layer while a chip resistor is being mounted on an electrode and/or while a thermal cycle test is being carried out.

Accordingly, if the solder in accordance with Example 6 is broken, the breakage is not caused by such a brittle layer, but is caused in the solder bulk. Thus, as proved in the results of measurement of a shearing strength, illustrated in FIG. 11, the solder in accordance with Example 6 has a higher mechanical strength than a solder not containing Ag. Furthermore, as proved in Examples 4 and 5, addition of Ag increases a strength of the solder.

### Reference Example 1

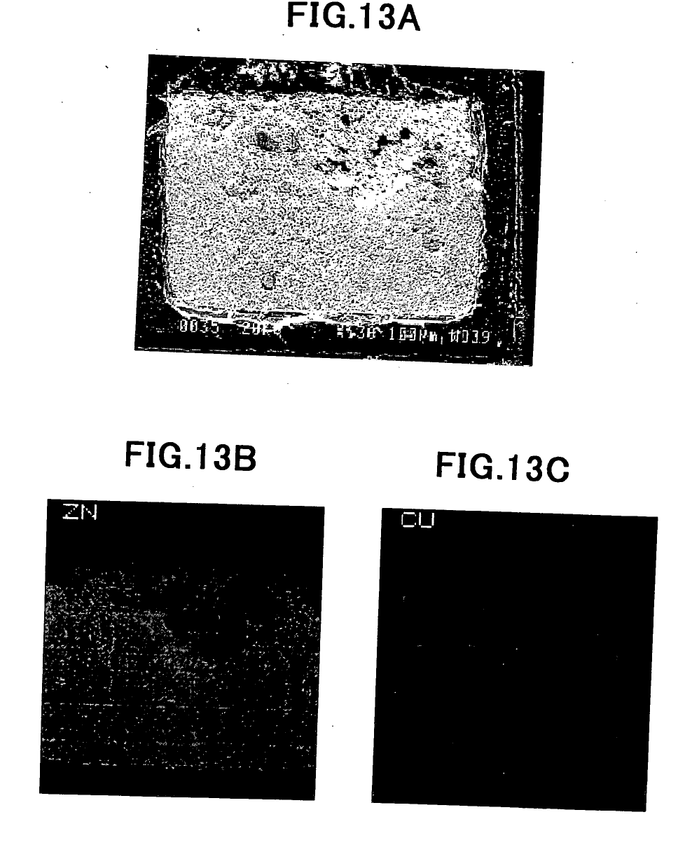

Similarly to FIGS. 12A, 12B and 12C, FIG. 13A is a SEM photograph of a broken-out section of a solder from which a chip resistor was peeled off after the above-mentioned measurement of a peeling strength in Example 6, FIG. 13B is EDX images (Zn profile), and FIG. 13C is EDX images (Cu profile). The solder used in Reference Example 1 does not contain Ag, and the circuit substrate used includes non-coated copper electrodes. The number of thermal cycles is 500.

Comparing FIGS. 13A, 13B and 13C to one another, it is obvious that Cu and Zn exist in a common area (almost all area) in the broken-out section, and Cu is scarcely found in an area where the solder exists. This means that Cu melts out of an electrode into the solder, and resultingly, there is formed a brittle Cu—Zn intermetallic compound layer at an interface between the electrode and the solder while a chip resistor is being mounted on an electrode and/or while a thermal cycle test is being carried out.

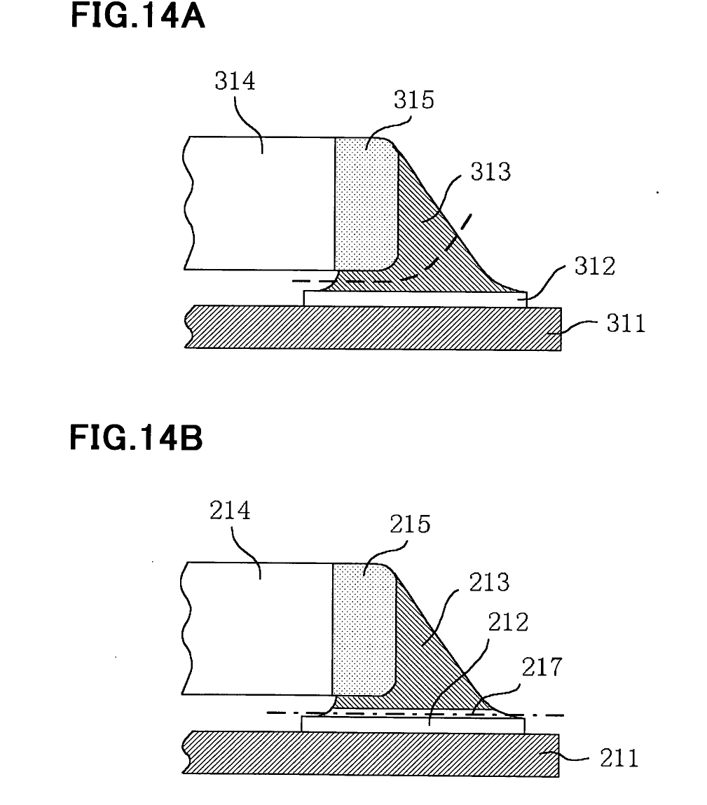

FIG. 14A is a cross-sectional view of a soldered portion before the solder is broken out in Example 6, and FIG. 14B is a cross-sectional view of a soldered portion before the solder is broken out in Example 6.

In FIGS. 14A and 14B, parts or elements that correspond to those of Example 1 illustrated in FIG. 3 have been provided with reference numerals having the same last two numerals, and are not explained.

As illustrated in FIG. 14B, in the solder not containing Ag in accordance with Reference Example 1, there is formed a brittle Cu—Zn intermetallic compound layer 217 at an interface between a copper substrate electrode 212 and a solder 213. Accordingly, the solder not containing Ag in accordance with Reference Example 1 is broken at the brittle Cu—Zn intermetallic compound layer 217, as indicated with a chain line in FIG. 14B. Hence, as is obvious in view of the results of the measurement o a shearing strength in Example 6, illustrated in FIG. 11, the solder in accordance with Reference Example 1 has a smaller strength than a solder containing Ag.

In contrast, as illustrated in FIG. 14A, in the solder containing Ag in accordance with Example 6, there is not formed a Cu—Zn intermetallic compound layer at an interface between a copper substrate electrode 312 and a solder 313. Accordingly, the solder in accordance with Example 6 is broken in the solder bulk 313, as indicated with a broken line in FIG. 14A.

In light of the above-mentioned results, it is concluded that the addition of Ag has an advantage in preventing formation of the brittle Cu—Zn intermetallic compound layer 217.

### Example 7

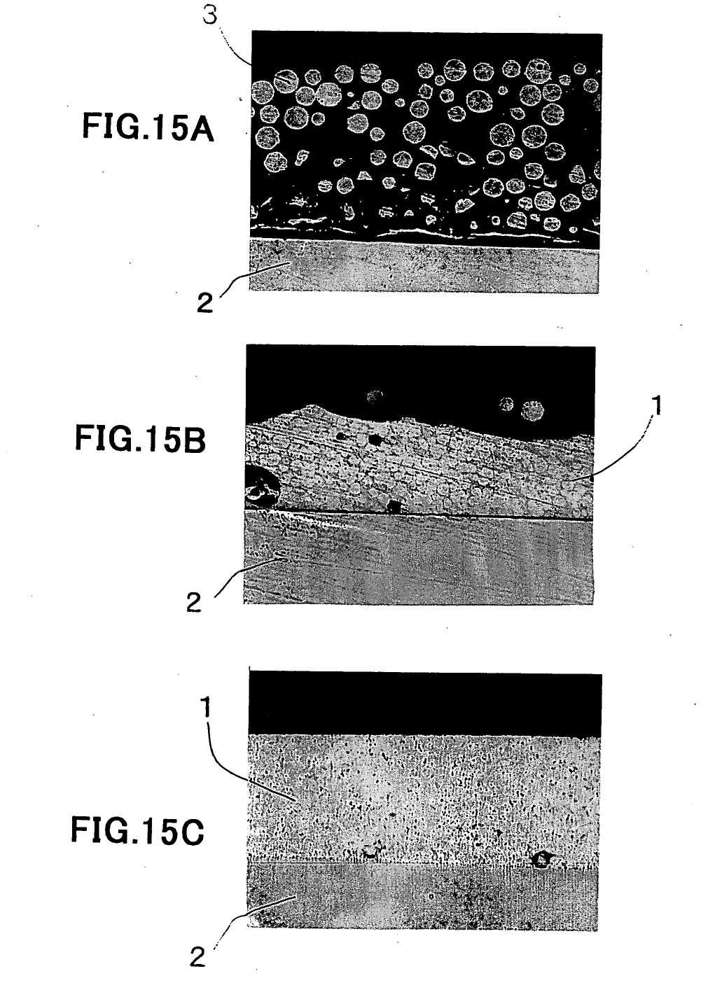

FIG. 15A is a cross-sectional SEM photograph taken just after the solder in accordance with Example 7 was printed onto a copper electrode, FIG. 15B is a cross-sectional SEM photograph taken after heated at a preheat temperature, and FIG. 15C is a cross-sectional SEM photograph taken after soldered.

First, there were fabricated a solder alloy comprised of Sn and Zn, and a solder alloy comprised of Sn, Bi and Ag. Then, the solders were powdered, and powders having a diameter in the range of 20 to 40 micrometers were separated out. Among the two solder alloys, Sn—Bi—Ag alloy having a smaller melting point has better wettability in atmosphere than that of Sn—Zn alloy having a higher melting point.

Then, the powders were mixed with weakly-active flux at such a mixture ratio that Zn is contained at 8 weight %, Bi is contained at 6 weight % or smaller, Ag is contained at 0.1 weight % or smaller, and a remainder is Sn, when molten, to thereby fabricate a creamy solder. A content of the flux was 12 weight %.

Then, the creamy lead-free solder was printed onto a copper plate.

As illustrated in FIG. 15A, just after the solder was printed onto a copper electrode, the above-mentioned two solders exist as alloy particles 3 in a flux formed on a copper plate 2. The solder alloy had particularly preferable printability, when particles in the two solder alloys were separated out to have a diameter in the range of 20 to 40 micrometers.

Then, the copper plate on which the above-mentioned creamy solder was printed was kept at 100 to 170 degrees centigrade for 30 to 120 seconds, wherein a temperature of 100 to 170 degrees centigrade is a pre-heat temperature in a conventional reflow-furnace used for reflowing Sn-37 wt. % Pb eutectic creamy solder. Thereafter, the copper plate was immersed in water to be rapidly cooled, in order to freeze the flux and the alloy in the environment.

As illustrated in FIG. 15B, the mixture solder 1 has a thickness smaller than a thickness observed just after the solder was printed onto a copper electrode, illustrated in FIG. 15A, and the solder alloy having a smaller melting point and further having good wettability spreads in wet condition over the copper plate. The solder alloy having a higher melting point remains in particles. The molten solder alloy having a smaller melting point flows into a gap formed between adjacent particles of the solder alloy having a higher melting point.

Oxygen contained in an oxide film formed on surfaces of particles of the solder alloy having a higher melting point is dissolved into the solder alloy having a smaller melting point, as dissolved oxygen contained in the molten solder alloy having a smaller melting point. When a concentration of the oxygen reaches a saturation concentration, the oxygen is released into atmosphere. This is equivalent to that an oxide film formed on surfaces of particles of the solder alloy having a higher melting point is reduced.

Similarly, even when there exist two or more solder alloys having a higher melting point, and a compound of oxygen, hydrogen, nitrogen or sulfur is formed on a surface of particles of the solder alloys, it would be possible to allow each of gases to dissolve as dissolved gas contained in the solder alloy having a smaller melting point, and to be released into atmosphere when a concentration of each of gases reaches a saturation concentration.

After the copper plate on which the creamy solder was painted was kept at 100 to 170 degrees centigrade as a pre-heat temperature for 30 to 120 seconds, the copper plate was kept at 210 to 240 degrees centigrade for about 30 seconds without being immersed into water, and then, was immersed into water for rapid cooling in order to freeze the flux and the alloy in the environment.

As illustrated in FIG. 15C, particles of the solder alloy having a higher melting point were molten, and thus, the mixture solder 1 had a uniform structure in a cross-section even after being cooled.

In Example 7, the particles of the two solder alloys were separated out to have a diameter in the range of 20 to 40 micrometers. However, a diameter of the particles is not to be limited to this. For instance, if a difference between a maximum diameter and a minimum diameter is equal to about 10 micrometers, as an average diameter of the particles is smaller than 20 micrometers, it would be possible to print a creamy solder onto a copper plate through a metal mask having a narrower pitch, in comparison with a case in which the particles have a diameter in the range of 20 to 40 micrometers.

The better the wettability of the solder is, after reflowed, the higher a ratio of a solder alloy having a smaller melting point and better wettability is in a mixture ratio in particles of the two solder alloys.

In addition, gases to be released from a surface of particles of the two or more alloys is not to be limited to oxygen, hydrogen, nitrogen and sulfur.

### Example 8

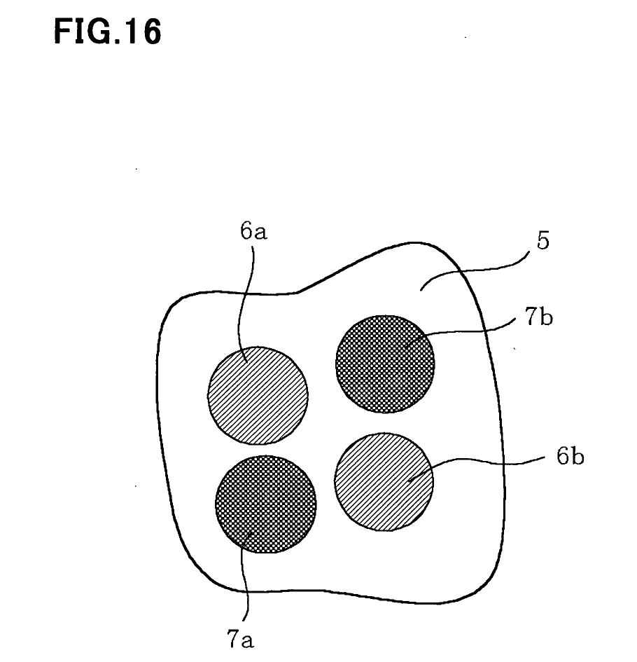

FIG. 16 is a cross-sectional view of a structure observed just after the solder in accordance with Example 8 was printed onto an electrode of a copper plate.

As illustrated in FIG. 16, the solder in accordance with Example 8 contains alloy particles 6a, 6b and 7a, 7b in a flux 5 just after being printed onto an electrode formed on a copper plate. The particles 6a and 6b have compositions different from each other, and are comprised of Sn and Zn, and the particles 7a and 7b have compositions different from each other, and are comprised of Sn, Bi and Ag.

The alloy particles 6a, 6b, 7a and 7b exist in the flux at such a mixture ratio that, when molten, the solder contains Zn at 8 weight %, Bi at 6 weight % or smaller, Ag at 0.1 weight % or smaller, and a remainder of Sn.

The Sn—Bi—Ag alloy has a smaller melting point and better wettability in atmosphere than those of the Sn—Zn alloy. The solder alloys are fabricated in the same manner as Example 7.

Similarly to Example 7, the solder in accordance with Example 8 makes it possible to solder an electronic component onto an electrode formed on a copper plate with preferable wettability.

The number of alloy particles to be contained in the solder is not to be limited to two. The solder may contain three or more alloy particles.

By arranging the alloy particles to have the same diameter, it would be possible to have the same printability as that of a creamy solder comprised of particles of a single alloy. However, it is not always necessary for the alloy particles to have the same diameter.

Even if particles of a solder alloy having a smaller melting point are likely to be oxidized, resulting in poor wettability onto an electrode of a substrate, it would be possible to improve wettability of a creamy solder containing particles of a plurality of alloys by coating the particles on a surface thereof with organic material or inorganic material such as metal for preventing oxidation of the particles. As such organic material, there may be preferably used organic compounds such as organic phosphorus compounds, or a preservative containing organic acid. As such metal, there may be preferably used metals which are more likely to be oxidized than Sn or Zn at a temperature close to a room temperature, such as Cr, Mn, Si, Ti or Al, or metals which forms a passive-state film when oxidized, such as Fe, Ni, Co, Cr, Ti, Nb, Ta or Al. It is possible to further improve wettability of the solder by coating particles of a solder alloy having a higher melting point, with such organic or inorganic material as mentioned above.

If an electrode formed on a circuit substrate is composed of copper, wettability of the solder to copper has to be considered. If a circuit substrate is turned at a surface thereof into gold, nickel, Sn—Bi alloy, Sn—Zn alloy, Sn—Ag alloy or Sn—Pb alloy when surface-treated, it would be necessary take wettability to those metals into consideration.

Though not explicitly indicated in the description made above, the solder in accordance with the present invention does not exclude containing a slight amount of impurities contained in Sn, Zn, Bi or Ag, or transferred from a crucible in a fabrication process.

While the present invention has been described in connection with certain preferred examples, it is to be understood that the subject matter encompassed by way of the present invention is not to be limited to those specific examples. On the contrary, it is intended for the subject matter of the invention to include all alternatives, modifications and equivalents as can be included within the spirit and scope of the present invention.

For instance, the solder in accordance with the present invention is used preferably for soldering electronic components to each other or an electronic component onto a circuit board. However, objects to which the solder in accordance with the present invention is used are not to be limited to those.

In dependence on a use, the solder in accordance with the present invention may be used as an ingot for inserting an electronic component into a substrate or a thread-solder for soldering a screw, as well as a creamy solder for soldering an electronic component onto a surface of a substrate. A use of the solder in accordance with the present invention is not to be limited to those.

When the solder in accordance with the present invention is used as a creamy solder, particles having a diameter in the range of 20 to 40 micrometers are preferably selected. If electrodes are arranged at a small pitch or a creamy solder is to be printed onto a small area, there may be selected particles having a diameter smaller than 20 micrometers.

The creamy solder may contain a flux at about 9 to about 13 weight % both inclusive in dependence on stability in reservation and/or printability.

A circuit substrate may be comprised of a ceramics substrate, a glass substrate or a glass epoxy substrate. As an alternative, a circuit substrate may be comprised of a printed wiring board or a Si substrate. However, a circuit substrate is not to be limited to those.

An electrode of a circuit substrate may be surface-treated preferably with Cu, Au, Sn, Sn—Pb alloy, Sn—Ag—Cu alloy, Sn—Zn alloy or a flux. However, materials with which an electrode of a circuit substrate is surface-treated are not to be limited to those.

As an electronic component to be soldered onto a circuit substrate, there may be selected a chip resistor, a chip capacitor, a LSI bare chip, SOP (Small Outline Package), QFP (Quad Flat Package), BGA (Ball Grid Array), DIP (Dual Inline Package) or PGA (Pin Grid Array). However, an electronic component to be soldered onto a circuit substrate is not to be limited to those.

While the present invention has been described in connection with certain preferred embodiments, it is to be understood that the subject matter encompassed by way of the present invention is not to be limited to those specific embodiments. On the contrary, it is intended for the subject matter of the invention to include all alternatives, modifications and equivalents as can be included within the spirit and scope of the following claims.

The entire disclosure of Japanese Patent Application No. 2002-195433 filed on Jul. 4, 2002 including specification, claims, drawings and summary is incorporated herein by reference in its entirety.

1-8. (canceled)

9. A solder comprising zinc at 7 to 10 weight % both inclusive, bismuth at 0.001 to 6 weight % both inclusive, silver at 0.001 to 0.1 weight % both inclusive, and the remainder of tin.

10. The solder as set forth in claim 9, wherein said solder is in the form of powder.

11. The solder as set forth in claim 10, wherein said powder has a diameter in the range of 20 to 40 micrometers both inclusive.

12. The solder as set forth in claim 10, wherein a difference between a maximum diameter of said powder and a minimum diameter of said powder is equal to or smaller than 10 micrometer.

13. The solder as set forth in claim 10, wherein said solder is mixed in flux.

14. The solder as set forth in claim 13, wherein said flux has a concentration in the range of 9 to 13 weight % both inclusive.

15. A solder comprising Sn—Zn alloy(s) having a single composition ratio or a plurality of composition ratios, and Sn—Bi—Ag alloy(s) having a single composition ratio or a plurality of composition ratios, said solder including zinc at 7 to 10 weight % both inclusive, bismuth at 0.001 to 6 weight % both inclusive, silver at 0.001 to 0.1 weight % both inclusive, and the remainder of tin when said alloys are melted in mixture.

16. The solder as set forth in claim 15, wherein said solder is in the form of powder.

17. The solder as set forth in claim 16, wherein said powder has a diameter in the range of 20 to 40 micrometers both inclusive.

18. The solder as set forth in claim 16, wherein a difference between a maximum diameter of said powder and a minimum diameter of said powder is equal to or smaller than 10 micrometer.

19. The solder as set forth in claim 16, wherein said solder is mixed in flux.

20. The solder as set forth in claim 19, wherein said flux has a concentration in the range of 9 to 13 weight % both inclusive.

21. A circuit substrate unit comprising a circuit board, and at least one electronic component soldered onto said circuit board,
wherein said electronic component is soldered onto said circuit board through a solder, and
said solder contains zinc at 7 to 10 weight % both inclusive, bismuth at 0.001 to 6 weight % both inclusive, silver at 0.001 to 0.1 weight % both inclusive, and the remainder of tin.

22. The circuit substrate unit as set forth in claim 21, wherein said solder is in the form of powder.

23. The circuit substrate unit as set forth in claim 22, wherein said powder has a diameter in the range of 20 to 40 micrometers both inclusive.

24. The circuit substrate unit as set forth in claim 22, wherein a difference between a maximum diameter of said powder and a minimum diameter of said powder is equal to or smaller than 10 micrometer.

25. The circuit substrate unit as set forth in claim 22, wherein said solder is mixed in flux.

26. The circuit substrate unit as set forth in claim 25, wherein said flux has a concentration in the range of 9 to 13 weight % both inclusive.

27. A circuit substrate unit comprising a circuit board, and at least one electronic component soldered onto said circuit board,
wherein said electronic component is soldered onto said circuit board through a solder, and
said solder contains Sn—Zn alloy(s) having a single composition ratio or a plurality of composition ratios, and Sn—Bi—Ag alloy(s) having a single composition ratio or a plurality of composition ratios, said solder including zinc at 7 to 10 weight % both inclusive, bismuth at 0.001 to 6 weight % both inclusive, silver at 0.001 to 0.1 weight % both inclusive, and the remainder of tin when said alloys are melted in mixture.

28. The circuit substrate unit as set forth in claim 27, wherein said solder is in the form of powder.

29. The circuit substrate unit as set forth in claim 28, wherein said powder has a diameter in the range of 20 to 40 micrometers both inclusive.

30. The circuit substrate unit as set forth in claim 28, wherein a difference between a maximum diameter of said powder and a minimum diameter of said powder is equal to or smaller than 10 micrometer.

31. The circuit substrate unit as set forth in claim 28, wherein said solder is mixed in flux.

32. The circuit substrate unit as set forth in claim 31, wherein said flux has a concentration in the range of 9 to 13 weight % both inclusive.
